(19) United States
(12) Patent Application Publication
(10) Pub. No.: US 2003/0025425 A1
(43) Pub. Date: Feb. 6, 2003

(54) Guiding device for drawer

(76) Inventor: Hoff Fu Chia Cheng, Ping Tong (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/921,571

(22) Filed: Aug. 6, 2001

(51) Int. Cl. E05B 53/00

(52) U.S. Cl. 312/218; 312/217; 312/219; 312/221

(57) ABSTRACT

A guiding device for drawer is disclosed. The device comprises a cupboard body having a vertical slot at the inner wall thereof near to the external edge of the cupboard body, and a plurality of drawers. A plurality of safety connection blocks are mounted to the slot so that only a sliding space is provided. The top and bottom sides of each safety connection blocks are provided with rollers, so that when a drawer is withdrawn, the rail board located at the side of the drawer will squeeze in between two adjacent rollers and the sliding space of the slot is fully filled. This will cause the other safety connection blocks to mutually urge against each other and other drawers are restricted from withdrawal.

### BACKGROUND OF THE INVENTION

(a) Field of the Invention

The present invention relates to a guiding device for drawer. The guiding device comprises a cupboard body having a lateral slot at the inner wall thereof, arranged close to the external front edge of the cupboard body, and a plurality of drawers. A plurality of safety connection blocks are mounted to the vertical slot so that only a sliding space is formed. The top and bottom sides of each safety connection blocks are provided with rollers, so that when a drawer is withdrawn or pulled out, a pair of rail board located at the sides of the drawer will squeeze in and to be located between two adjacent rollers, and the sliding space of the lateral slot is fully filled. This will cause the other safety connection blocks to mutually urge against each other and other drawers are restricted from withdrawal.

(b) Description of the Prior Art

FIG. 1 is a conventional combination of cupboard and a plurality of drawers structure having a cupboard body 1, a plurality of drawers 2 and rail boards 3. An engaging board 22 is formed at the two lateral sides of the drawer 2 such that the engaging board 22 will engage with sliding rails 12 when the drawer 2 is pulled out. However, when a plurality of drawers 2 are pulled out at a same time, the cupboard with the drawers structure will be toppled. As shown in FIG. 2, a slot 13 is provided at one side of the cupboard body 1 being close to the front end thereof, and a connection block 3 is provided within the slot 13. When a drawer 2 is pulled out, as shown in FIG. 3, the connection block 3 together with the corresponding rollers 31 will rise along the sloping end of a rail board 23 of the drawer 2, and the connection block 3 will move upward. The other rollers 31 will move upward so as to prevent other drawers 2 from being pulled out. As shown in FIG. 4, if one drawer 2 is pulled out, the other drawers 2 will also be pulled out at the same time, and the roller 31 corresponding to the other drawers 2 and the connection block 3 will rise along the sloping end of the rail board 23, and two drawers 2 may be pulled out at the same time. Thus, the combination of the cupboard and the drawer may topple over.

### SUMMARY OF THE INVENTION

Accordingly, it is an object of the present invention to provide a guiding device for drawer, wherein the device comprises a cupboard body having a lateral slot at the inner wall thereof being located close to the external edge of the cupboard body, and a plurality of drawers. A plurality of safety connection blocks are mounted to the lateral slot so that only a sliding space is provided. The top and bottom sides of each safety connection blocks are provided with rollers, so that when a drawer is withdrawn or pulled out thereof, the rail board located at the side of the drawer will squeeze in between two adjacent rollers and the sliding space of the slot is fully filled. This will cause the other safety connection blocks to mutually urge against each other and other drawers are restricted from withdrawal.

Yet another object of the present invention is to provide a guiding device for drawer comprising a cupboard body and a plurality of drawers being slidable within the cupboard body, a vertical slot being formed at the inner wall of the cupboard body, close to the external edge of the cupboard body and the lateral sides of the drawer being respectively mounted with a rail board and the front end of the rail board being a sloping end which is bent downward, characterized in that the lower section of the vertical slot is provided with a position block being sequentially mounted with a plurality of safety connection blocks having mounted with rollers at the top and bottom side, the top of the safety connection block is provided with an urging block and a locking block and the bottom side of the urging block is provided with rollers, the locking block is locked by the latch of a locker to the top of the vertical slot, and a sliding space is formed between the locking block and the urging block, and the width of the sliding space is substantially equal to the thickness of the rail board, and the sloping end of the rail board is in alignment with the rollers located between the adjacent safety connection blocks.

A further object of the present invention is to provide a guiding device for drawer comprising a cupboard body and a plurality of drawers being slidable within the cupboard body, a vertical slot being formed on the inner wall of the cupboard body, close to the external edge of the cupboard body and the lateral sides of the drawer being respectively mounted with a rail board and the front end of the rail board being a sloping end which is bent downward, characterized in that the lower section of the vertical slot is provided with a position block being sequentially mounted with a plurality of safety connection block having rollers at the top and bottom side, the top of the safety connection block is provided with a locking block, and the bottom side of the locking block is provided with rollers, the locking block is locked by the latch of a locker to the top of the slot, and a sliding space is formed between the locking block and the urging block, and the width of the sliding space is substantially equal to the thickness of the rail board, and the sloping end of the rail board is in alignment with the roller located between the adjacent safety connection blocks.

Other object and advantages of the present invention will become more apparent from the following description taken in conjunction with the accompanying drawings.

### BRIEF DESCRIPTION OF THE DRAWINGS

FIG. 1 is an exploded view of a conventional drawer and cupboard combination.

FIG. 2 is a schematic view showing the insertion of the conventional drawer into the cupboard.

FIG. 3 is a schematic view showing the withdrawal of a conventional drawer from the cupboard.

FIG. 4 is a schematic view showing two of the conventional drawers being withdrawn.

FIG. 5 is an exploded view of the preferred embodiment of the present invention.

FIG. 6 is a schematic view showing the closure of drawer of FIG. 5 of the present invention.

FIG. 7 is a schematic view showing the opening (pulling out) of drawer of FIG. 5 of the present invention.

FIG. 8 is a schematic view showing the unlocking of the locker of FIG. 5.

FIG. 9 is an exploded perspective view of another preferred embodiment of FIG. 5.

FIG. 10 is a schematic view showing the closure of drawers shown in FIG. 9.

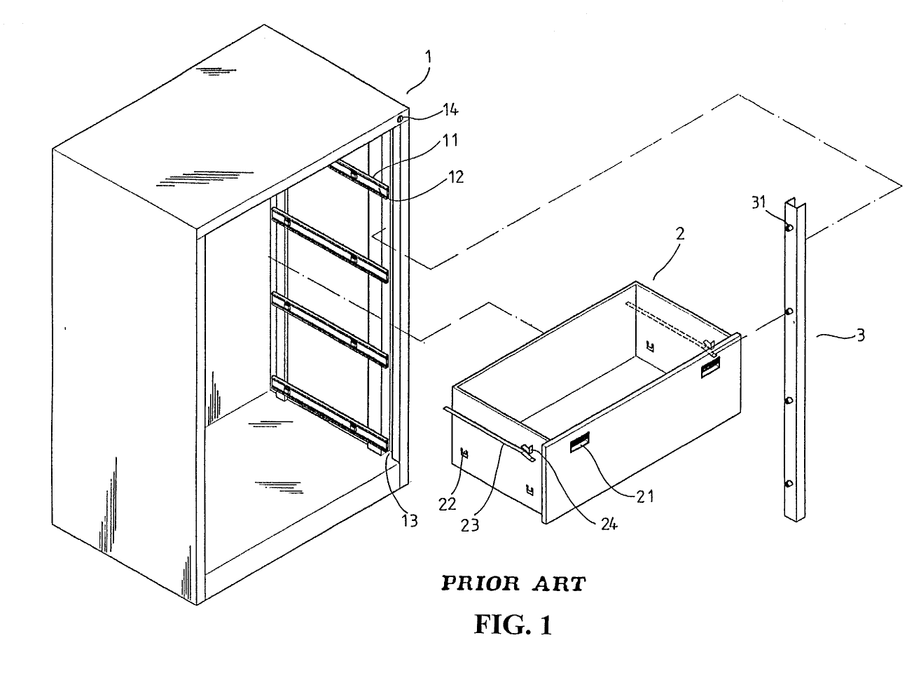

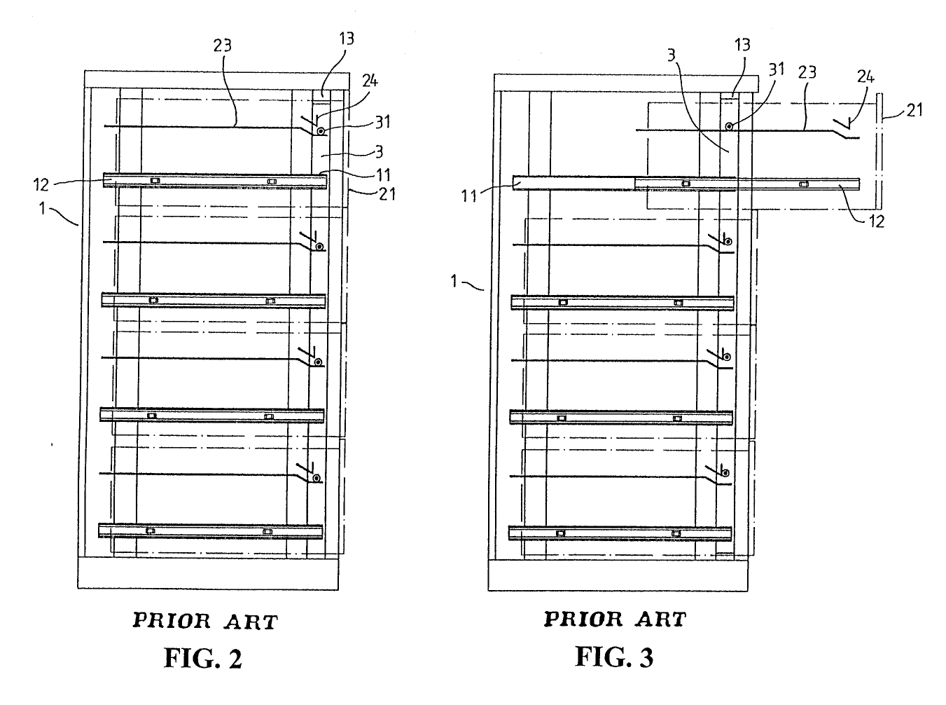

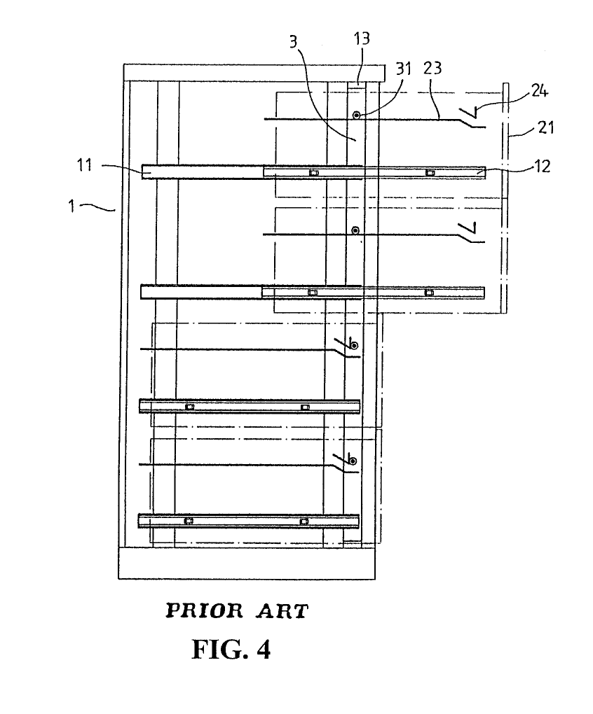

### DETAILED DESCRIPTION OF THE PRESENT INVENTION

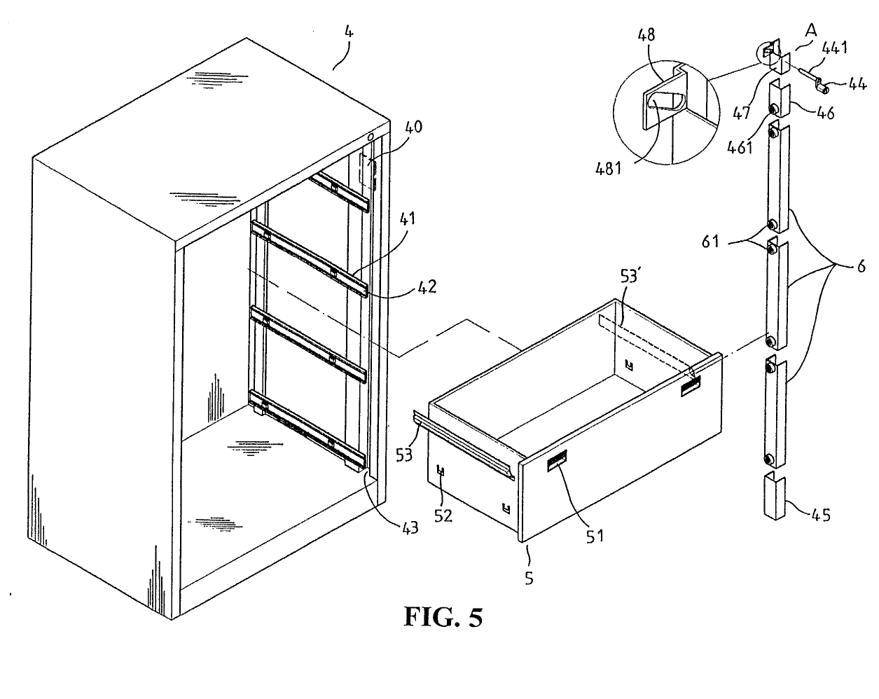

Referring to FIG. 5, there is shown a guiding device for drawer comprising a cupboard body 4 and a plurality of drawers (only one of the drawer being shown) 5. The two sides of the inner wall of the cupboard body 4 are provided with a frame board 41 enclosed a sliding rail 42. Near to the front end of the inner wall, a vertical slot 43 is provided, and the front end of the drawer 5 is mounted with a handle 21. The two lateral sides of the drawer 5 are punched to form respectively an engaging plate 52 which can be engaged with the sliding rail 42 such that when the drawer 5 is withdrawn or inserted within the cupboard body 4 to allow the user to place documents or to access documents from the drawer 5. A locker 44 is provided at an appropriate position at the upper end of the slot 43 of the cupboard body 4 for the locking of the drawer 5. A rail board 53 is provided at the side of the drawer 5, and the rail board 53 has a thickness and has a sloping front end.

In accordance with the present invention, a position block 45 is located at the lower end of the slot 43, or a blocking board (not shown) having the same height of the slot 43 is located within the slot 43 to replace the block 45.

The top of the position block 45 is mounted with a plurality of safety connection blocks 6 being positioned within the slot 43 and covered by the frame board 42, and is slidable within the slot 43. The top and the bottom side of the safety connection block 6 are provided with rollers 61. The top side of the connection block 6 is sequentially positioned with an urging block 46 and a locking block 47, wherein the end of the lower side of the urging block 46 is provided with a roller 461, and the inner side of the locking block 47 is mounted with a latch board 48 having a sloping hole 481, and the locking latch 441 of the locker 44 can pass through the hole 481. By employing a key, the locking latch 441 can be driven within the hole 481 to move up and down so as to push the locking block 47 to slide up and down within the slot 43.

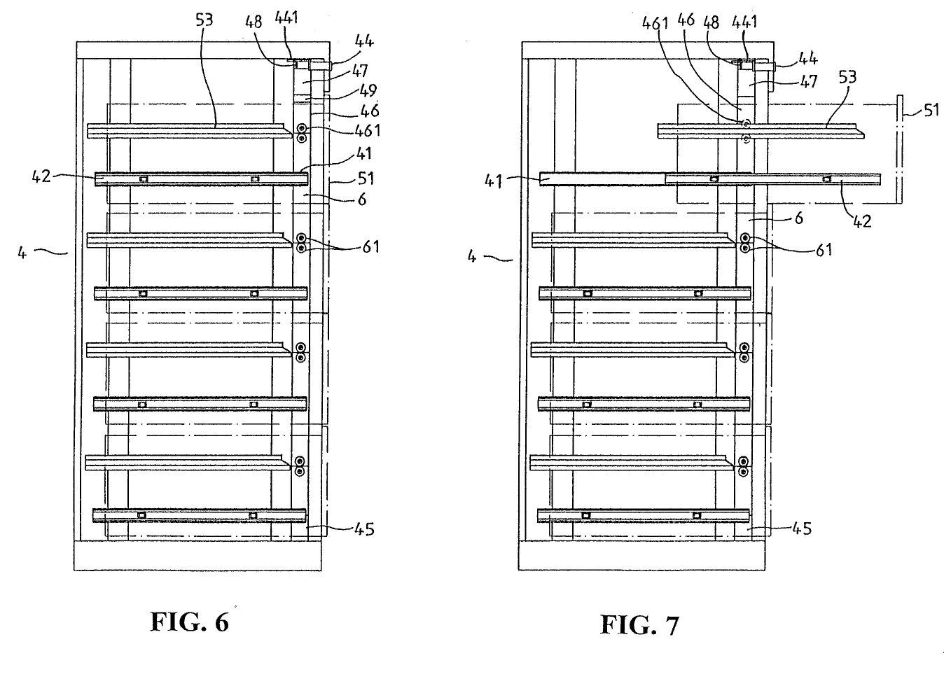

Referring to FIG. 6, if the locker 44 has not been locked, the locking latch 441 is positioned at the extreme top of the hole 481 and the locking block 47 is positioned at the extreme top side of the slot 43. The individual connection blocks 6 are located on top of the position block 45, and at the same time, the urging blocks 46 are stacked onto the extreme top of the connection block 6. Thus, only a sliding space 49 is formed between the urging block 46 and the locking block 47.

The width of the sliding space 49 is preferably equal to the thickness of the rail board 53. A cover board 40 is mounted onto the opening end of the slot 43 such that the urging block 46 and the locking block 47 is sealed within the slot 43 and will not be dislocated from the slot 43. Further the corresponding rollers 61 adjacent to the safety connection block 6 are in alignment with the rail board 53 of the drawer 5.

As shown in FIG. 7, when the drawer 5 is pulled out, the rail board 53 is extended into the rollers 461, 61 located at the urging block 46 and the safety connection block 6, and the rail board 53 is pulled out together with the drawer 5. That is, the rail board 53 is extended between the rollers 461 and 61, and the connection blocks 6 at the bottom side of the slot 43 are urged against each other. As only the sliding space 49 between the urging block 46 and the locking block 47 is available, if the height of the rail board 53 is increased, the urging block 46 will be pushed upward, and the raising of the urging block 46 will urge against the locking block 47. This will allow the drawer 5 to be withdrawn smoothly. At the same time, only the sliding space 47 is provided at the slot 43, after the upper drawer 5 is pulled out, the safety connection block 6 within the slot 43 will urge against each other and the lower drawers 5 cannot be withdrawn. Thus, only one drawer 5 can be withdrawn at one time and the toppling of the combination of cupboard with drawers is prevented.

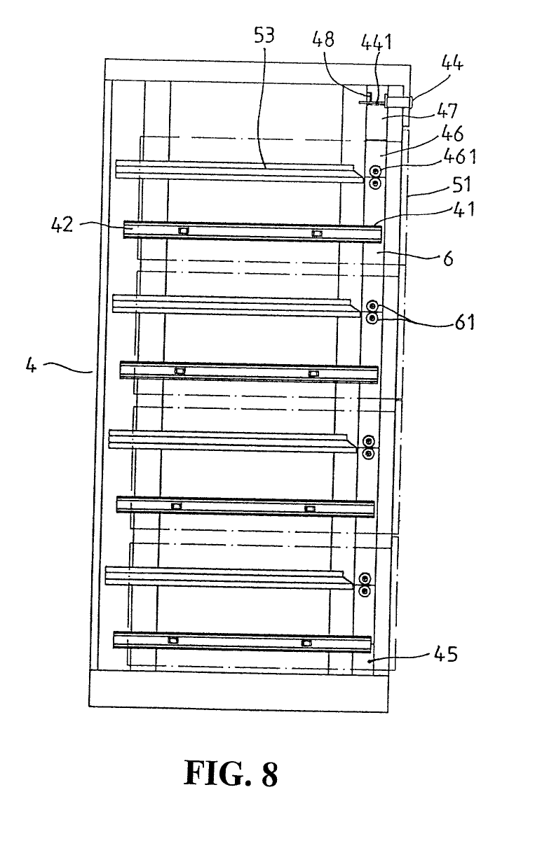

Referring to FIG. 8, when the key is turned to lock the drawers, i.e., the locking latch 441 is rotated. The locking latch 441 rotates to slide downward from the top of the hole 481 of the latch board 48 and urges the bottom of the hole 481 to push the locking block 47 to face downward, such that the locking block 47 and the urging block 46 are urged with each other. That is, the safety connection block 6 has no space to move up and down and the drawers are thus locked.

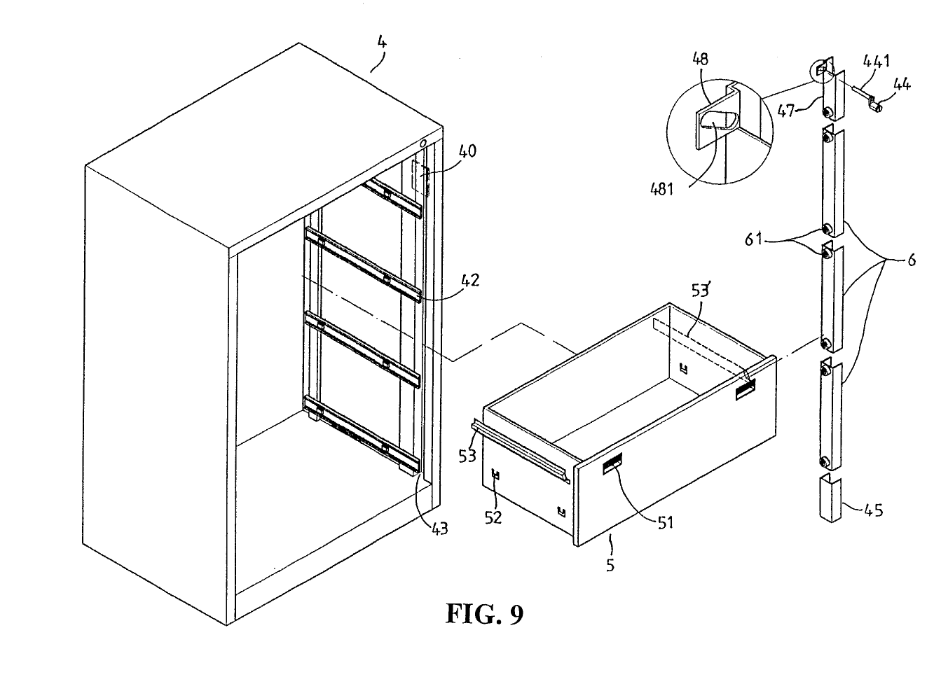

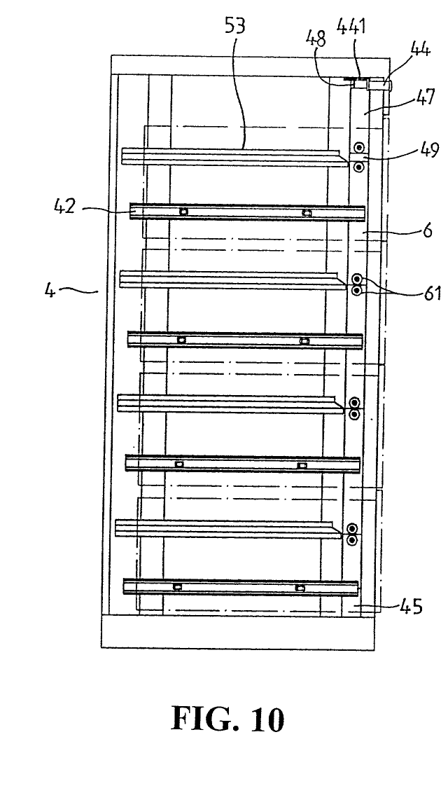

In operation, as shown in FIG. 9, the extreme top safety connection block 6 is provided with a locking block 47 and the length of the locking block 47 equals to the total length of the urging block 46 and the locking block 47. That is, two blocks can be changed into one single block. A covering plate 40 is used to cover the opening end of the slot 43 such that the locking block 47 is sealed within the slot 43. The inner lateral side of the locking block 47 is mounted with a latch board 48 having a sloping hole 481. The locking latch 441 of the locker passes through the hole 481. Referring to FIG. 10, as the latch board 48 can be passed through by the locker 44 and the locking block 47 urges at the upper most of the slot 43, a sliding space 49 is formed between the locking block 47 and the extreme top safety connection block 6. Similarly, the height of the sliding space 49 is preferably the same as the thickness of the rail board 53, such that one drawer can be withdrawn at one time.

While the invention has been described with respect to preferred embodiment, it will be clear to those skilled in the art that modifications and improvements may be made to the invention without departing from the spirit and scope of the invention. Therefore, the invention is not to be limited by the specific illustrative embodiment, but only by the scope of the appended claims.

I claim:

1. A guiding device for a drawer comprising a cupboard body and a plurality of drawers being slidable within the cupboard body, a vertical slot being formed on the inner wall of the cupboard body, close to the external edge of the cupboard body, and the lateral sides of the drawer being respectively mounted with a rail board and the front end of the rail board being a sloping end which is bent downward, characterized in that the lower section of the vertical slot is provided with a position block being sequentially mounted with a plurality of safety connection blocks having rollers at the top and bottom side, the top of the safety connection blocks is provided with an urging block and a locking block, and the bottom side of the urging block is provided with rollers, the locking block is locked by the latch of a locker to the top of the slot, and a sliding space is formed between the locking block and the urging block, and the width of the sliding space is substantially equal to the thickness of the rail board, and the sloping end of the rail board is in alignment with the rollers located between the adjacent safety connection blocks.

2. A guiding device for a drawer comprising a cupboard body are a plurality of drawers being slidable within the cupboard body, a vertical slot being formed on the inner wall of the cupboard body, close to the external edge of the cupboard body and the lateral sides of the drawer being respectively mounted with a rail board and the front end of the rail board being a sloping end which is bent downward, characterized in that the lower section of the vertical slot is provided with a position block being sequentially mounted with a plurality of safety connection blocks having rollers at the top and bottom side, the top of the safety connection block is provided with a locking block, and the bottom side of the locking block is provided with rollers, the locking block is locked by the latch of a locker to the top of the slot, and a sliding space is formed between the locking block and the urging block, and the width of the sliding space is substantially equal to the thickness of the rail board, and the sloping end of the rail board is in alignment with the rollers located between the adjacent safety connection blocks.

3. The guiding device of claim 1, wherein the position block located at the bottom section of the slot is positioned within the slot at a similar height.

4. The guiding device of claim 3, wherein the position block is replaced with a blocking board.
